(19) United States
(12) Patent Application Publication
(10) Pub. No.: US 2016/0088236 A1
(43) Pub. Date: Mar. 24, 2016

(54) AUDIO VIDEO CONTENT INPUT/OUTPUT CHASSIS SYSTEM

(71) Applicant: Randall John Bratton, Metuchen, NJ (US)

(72) Inventor: Randall John Bratton, Metuchen, NJ (US)

(21) Appl. No.: 14/957,615

(22) Filed: Dec. 3, 2015

(51) Int. Cl. H04N 5/268; H04N 5/44

(52) U.S. Cl. CPC H04N 5/268; H04N 5/4403; H04N 2005/4407

(57) ABSTRACT

The typical home has one primary television, and many entertainment appliances which provide audio-video content to that television. Prior to the present invention, there has never been an efficient way of managing the control of these appliances with a single remote control (universal remote control), and the switching of input ports such that a user can control which appliance is currently displaying its content on the television (content switching).

The reason these two functions have never been managed efficiently is because they are always performed by separate devices, which have no integration or cooperation with each other. Many homes have both, a hub-based universal remote control system, and a content switcher. But the traditional remote control hub cannot efficiently manage an entertainment system, because it does not have the access that a content switcher has to the appliances. Furthermore, the content switcher is one more appliance that the remote control hub needs to manage, and this adds complications and difficulties. The present invention dramatically improves on the efficiency and ability of both devices, the remote control hub and the content switcher, by intelligently merging both functions into a single processor.

### BACKGROUND OF THE INVENTION

1. Technical Field of the Invention

This invention relates to the electronics field, and specifically to the areas of audio video equipment and computer hardware and firmware. Any company that manufactures computers, network switches, HDMI splitters, A/V receivers, or similar products could easily build this invention. The invention could be readily produced using technology and components that are common today, combined with the designs disclosed in this document.

2. Description of Prior Art

Most households today have several content source appliances; that is, appliances that provide audio-video content to the television. To avoid having a clutter of cables connecting to the television, and to avoid running out of input ports on the television, many users have a device commonly called an HDMI splitter, or HDMI switcher. The HDMI cables from the content appliances connect to the switcher instead of to the television, and a single HDMI cable connects from the switcher's output port to an input port on the television. Because HDMI is not the only standard for content transmission, this document will use the more generic term “content switcher.” A content switcher can reduce the number of cables connecting to a television, but does not control the connected appliances. It acts primarily as a traffic director for the content, and leaves the controlling of the appliances to the individual remote control units (or “remotes”) of those appliances; or, in some cases, a single universal remote.

A universal remote, which is typically purchased separately from any appliances, allows the user to control multiple appliances with a single remote; but first, the user must program the universal remote to learn the command code set of each individual appliance. Appliance manufacturers have not agreed to use a common command set, and even appliances from the same manufacturer have different command codes. The universal remote's learning process is an unpleasant and often unsuccessful endeavor. In many cases, the user must aim the beam of the original appliance remote at a sensor on the universal remote, to “teach” the universal remote a command code. This step must be performed separately for each button or command on the remote.

Typically, if a user wants to watch content from an appliance, the user must perform multiple actions, on multiple devices. For example, if a user wants to watch a DVD, they may need to power on a DVD player, and the television, and the content switcher, and also command the content switcher to select the DVD player as the current input device. Not only does this require multiple steps, but for each of these steps the user may need to perform an additional action to change which device the universal remote is controlling.

Some existing universal remotes have a scripting feature. With these remotes, the user typically needs to program “activities.” If a remote has this feature, the user can program a single menu item on the remote to perform multiple actions, like powering on all the devices needed for a certain activity, and selecting an input (that is, selecting which source appliance will send content to the television). But even this scripting system has shortcomings.

For example, many appliances do not have the separate commands “Power On” and “Power Off′; instead, they have a single command called “Power Toggle”. If a script reaches a step where it needs a certain appliance powered on, and it does not know the appliance's existing power state, it cannot properly decide whether or not to send the Power Toggle command. The universal remote's “knowledge” of the current state of each setting is based entirely on “remembering” the last command that it (the remote itself) has sent to configure that setting.

For example, a user might have a script called “Play DVD.” One of the steps in this script is to turn on the television. If this user has a television that does not have Power On and Power Off commands, but only has a Power Toggle command, the script would have a step that says: “if the TV is powered off, send a Power Toggle command, otherwise do not.” The user might run the script by pressing a button on the remote. Then the user might fall asleep while watching a DVD, and the TV might automatically power off after a few hours. Then the next evening, the user might run that same script again. The remote “remembers” that the last script it executed powered the TV on, so it assumes that the TV is still on. The remote only remembers its own actions, and assumes that no other actions are performed on the devices. Therefore, in this example, since it thinks the TV is already on, it does not send the Power Toggle command, and the TV is not powered on.

Some existing universal remotes implement a hub-based system. A remote-control hub is a physical device which receives or intercepts commands issued by remote control units, via radio signals (RF), infrared signals (IR), wi-fi signals, or other means. The hub then interprets the signals, translates them if needed, and retransmits them to the appliances, using IR signals or whatever the appliances support. The hub may also be the primary storage location for the remote's configuration settings, including command codes and possibly scripts used to control appliances. However, the hub is a completely separate entity from the content switcher, and has no relationship or integration with the switcher, except that the switcher might be one of the various devices controlled by the hub.

Another shortcoming with today's entertainment devices is the physical footprint of the devices. A typical home has several content-providing appliances, all made in various shapes and sizes and yet needing to somehow fit together in the same cabinet or shelf space. Often, a user needs to stack the content appliances to save space, but cannot do so because of their non-standard shapes.

An even bigger concern is the enormous amount of waste that occurs in manufacturing these appliances. Each appliance contains a circuit board, with components that provide a function, and several “accessory” items: power supplies, power cords, network ports and cables, fans, and even the physical casing that houses the whole thing. If any single component fails—whether it be the primary component or one of the said accessory items—the entire appliance is typically discarded (and probably sent to a landfill), and replaced by a newly purchased appliance.

Yet another shortcoming in current entertainment devices is the need for repetitious configuration. When a user purchases an appliance, there are several configuration settings that need to be entered by the user, including things like time zone, preferred language, wi-fi settings, and so on. Many of these settings have the same values for all appliances that are in the same home, yet the user must repeatedly enter these same settings on every device. This is especially true for Internet streaming devices, where the settings include the user's account settings (login name, password, etc.) for multiple Internet streaming accounts.

Most remote-controlled appliances have an on-screen menu system that is used to configure the settings, using the television to view the menus. This is true even for appliances or appliance modes that otherwise do not require use of a television; for example, if an A/V receiver or a DVD player is being used to play audio only, it still requires powering on the television, to view and select audio tracks on-screen. In these cases, it may be inconvenient, and energy inefficient, for the user to have to turn the television on, just to see the configuration menus or to select audio tracks.

### SUMMARY OF THE INVENTION

The invention consists primarily of a physical chassis, which acts as an enhanced version of a content switcher. That is, the chassis contains several input ports which accept connections from content appliances, and at least one output port which can send content to a television. Using a remote control system, the user can select between the input ports on the chassis, thereby selecting which of the connected appliances is sending its content to the television.

In addition to the basic function of a content switcher as described above, the invention also controls the connected appliances. Such appliances may be manufactured as cartridges which insert into slots in the chassis, or as external appliances. External appliances have a bidirectional control channel on the content cable, which allows the invention to control the appliance.

The invention works with a remote control unit, which acts as a highly evolved version of a “universal remote.” The remote uses a hub-based system, with the chassis itself serving as the remote control hub. The commands issued by the remote are received only by the chassis, and processed by the controller component inside the chassis, which in turn uses command codes to control the appliances. When the user selects an appliance using the remote, this single user action performs two tasks: it sets the selected appliance as the one currently controlled by the remote, and it also sets that same appliance as the active input so its content is sent to the television.

### BRIEF DESCRIPTION OF DRAWINGS

### Drawing Figure Description

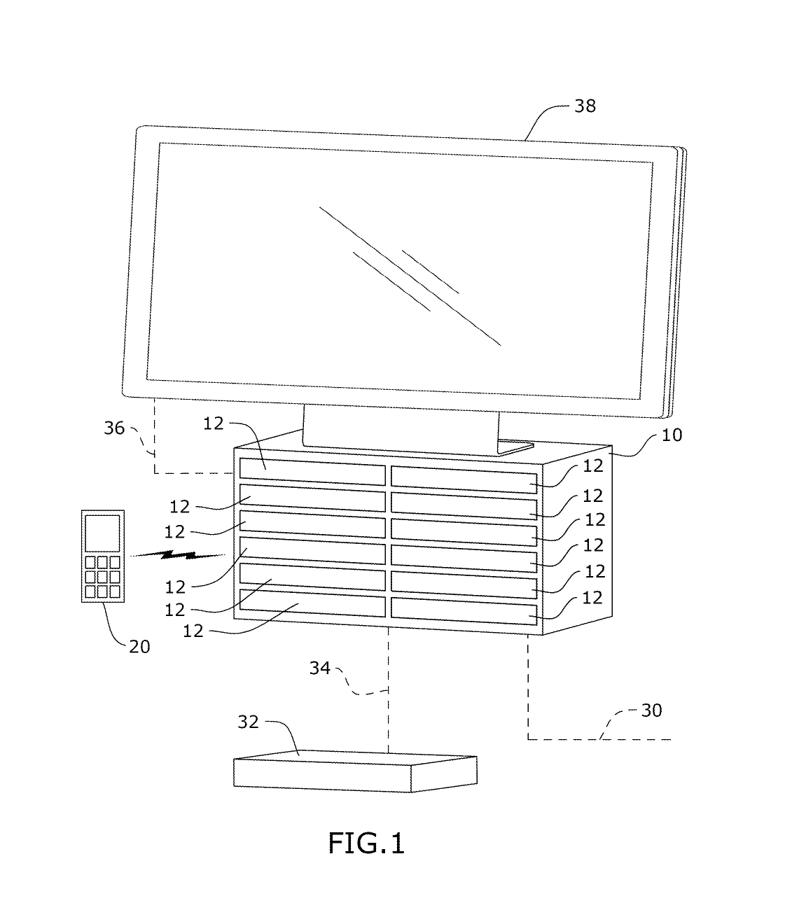

FIG. 1: is a perspective/schematic view of the invention.

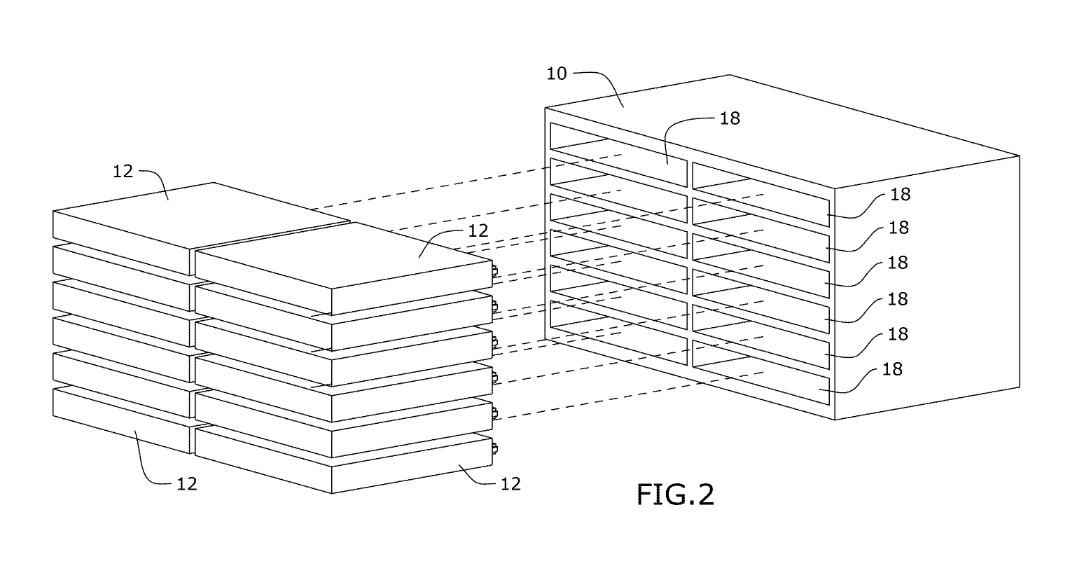

FIG. 2: is an exploded view of the invention.

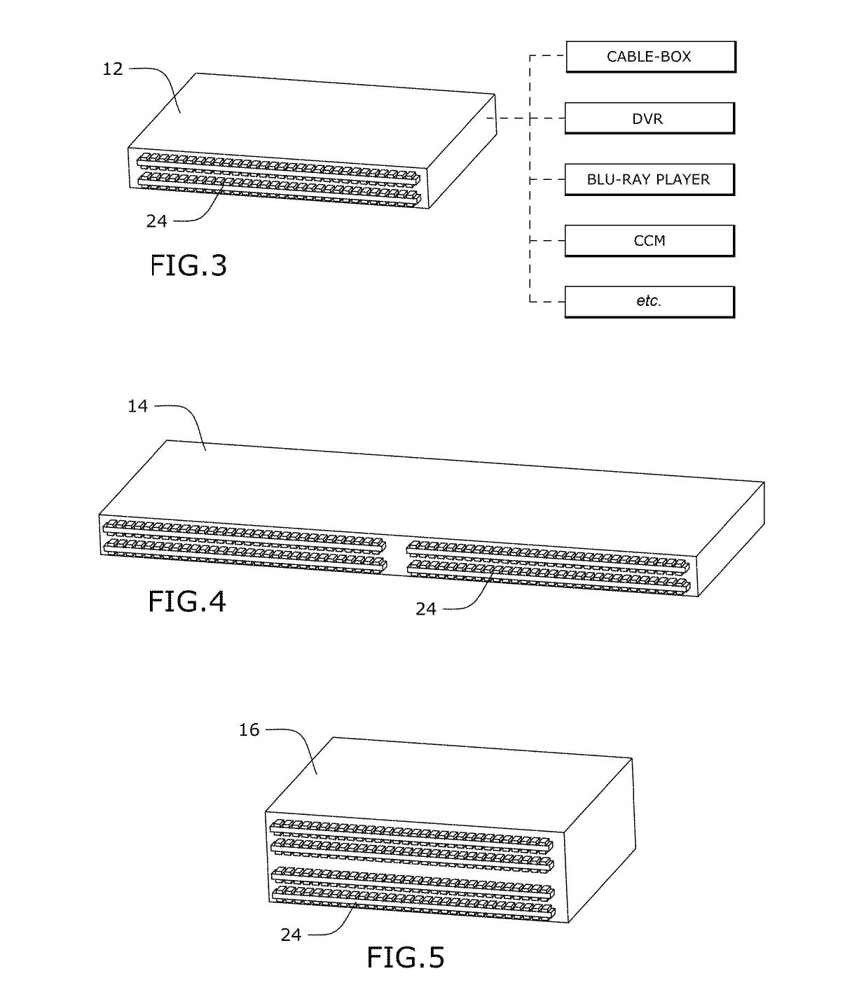

FIG. 3: is a rear view of the invention component 12 appliance cartridge.

FIG. 4: is a rear view of the invention component 14 double-width cartridge.

FIG. 5: is a rear view of the invention component 16 double-height cartridge.

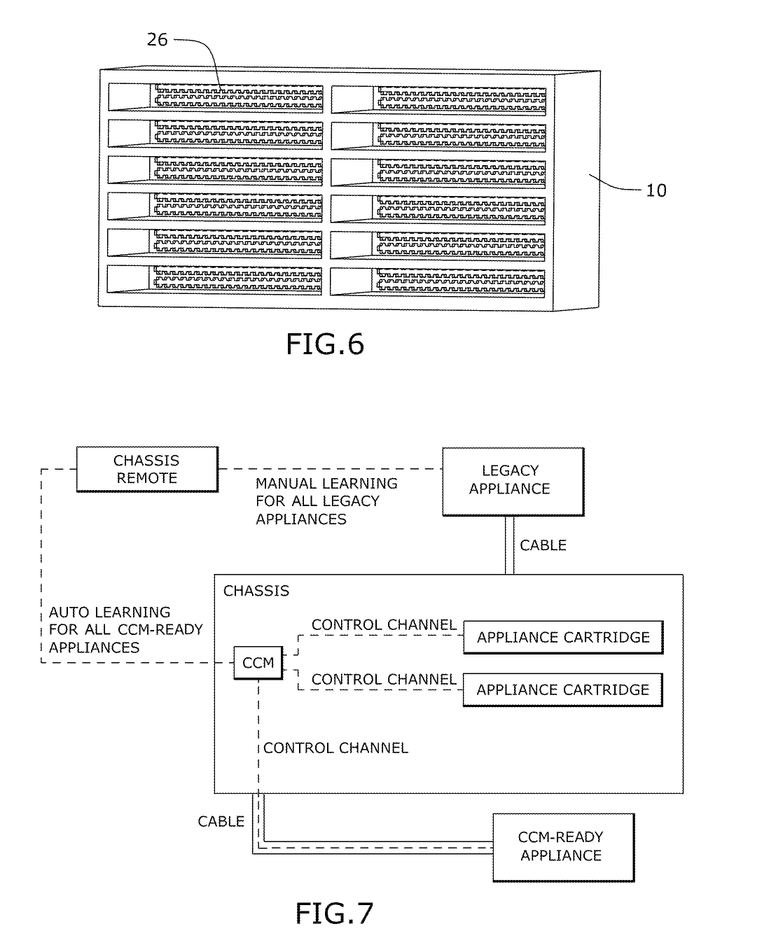

FIG. 6: is a front view of the invention chassis only.

FIG. 7: is a schematic view of the invention.

### ITEMIZED PARTS LIST

10: is the physical chassis.
12: is the appliance cartridge.
14: is the double-width cartridge.
16: is the double-height cartridge.
18: is the physical chassis slot for appliance cartridge.
20: is the remote control unit (the “remote”).
24: is the cartridge male connector.
26: is the physical chassis slot female connector.
30: is the wired signal connection to wall exemplification (i.e. CATV wall jack).
32: is the CCM-ready external appliance.
34: is the wired connection from the external appliance to the chassis input port.
36: is the wired connection from the chassis output port to the television.
38: is the television.

Note: Although the invention is illustrated in exemplary embodiments, it should be noted that modifications in component configuration and design may be made without departing from the spirit and scope of the invention, as is known by those in the arts.

### DETAILED DESCRIPTION OF THE INVENTION

### The Preferred Embodiment of the Invention

This section describes the ideal embodiment of the invention as imagined by the inventor; therefore, much of what is described in this section is not necessary to the invention. In this section, any time a reference is made to “the invention” or “the present invention” having a particular feature, it simply means that this preferred embodiment of the invention has said feature. Such phrasing certainly does not limit the scope of the invention to devices having said feature.

The primary physical component of the invention is a chassis 10 that has input and output ports, and performs the functions of a traditional audio-video content switcher. That is, the chassis 10 receives content on one or more input ports; and the content from only one of those input ports, which is selected by the user via remote control, is sent out the output port, on a single cable 36 to the television 38. Content sources are typically appliances, such as cable-boxes, DVRs, DVD players and video game systems. However, content sources may also include connections from service providers cables 30, such as a CATV cable connecting directly from a wall jack to an input port on the chassis 10.

An A/V receiver is an existing device found in many homes today, which is essentially the same as a content switcher, but with additional audio features, including the ability to output audio to a stereo speaker set. Since the present invention performs the content switcher function, it naturally follows that it can also serve the A/V receiver function, if the manufacturer chooses to add the additional audio features, either built-in or as an add-on component. In this document, the audio equipment that may be added to the present invention to attach speakers will be referred to as an A/V receiver component, or simply an A/V receiver.

Within the chassis 10 is an intelligent processor component, consisting of a firmware chip or whatever is the functional equivalent of the time period. This processor manages the content switching and all other functions of the invention. In this document, said processor is referred to as the Chassis Controller Module (CCM), as labeled in FIG. 7. The CCM is the primary functional component of the invention, and the chassis 10 is the physical housing in which this processor resides.

While the present invention includes the functionality of a traditional content switcher as described above, it dramatically improves on existing implementations, by adding the ability to control the connected appliances. The CCM component in the chassis 10 controls the functions of appliances that connect to the chassis 10. In this document, appliances that are manufactured to work with the present invention are henceforth referred to as “CCM-ready appliances.” Appliances that are not CCM-ready are referred to as “legacy appliances.” Both appliance types are indicated in FIG. 7.

In the preferred embodiment of the invention, content appliances such as the ones listed earlier (cable-boxes, DVD players, etc.) are manufactured as cartridges 12, and the chassis 10 contains slots 18 designed to accept said cartridges 12. The inserted end of each cartridge 12 has one or more physical connectors 24; and when a cartridge 12 is inserted into a slot 18, it connects to a corresponding set of connectors 26 inside the chassis 10. As with PC docking stations, the number of functions provided by the connectors is not limited to the visible number of physical connectors; that is, what appears to be a single physical connector may actually consist of multiple connectors providing different functions.

Because the appliances are manufactured as cartridges 12, they do not need to contain accessory items such as cables, ports, fans, power supplies, power cords, or remote control sensors. All of these items are part of the chassis 10 or attached to the chassis 10, and their functionality is essentially shared by all of the cartridges 12. However, CCM-ready appliances are not required to be manufactured as cartridges 12. A manufacturer may choose to build an external (non-cartridge) CCM-ready appliance 32.

In the preferred embodiment of the invention, the content cable 34 of an external CCM-ready appliance 32 has a bidirectional control channel, which is used to exchange control messages between the CCM and the appliance. When any CCM-ready appliance initially connects to the chassis 10, whether it be a cartridge 12 or an external appliance 32, there is a registration process. The appliance registers itself to the system, and provides the CCM with its information, including appliance type, manufacturer, model, serial number, etc. The chassis 10 also provides information to the appliance, including the current date and time. CCM-ready appliances do not need to have their own embedded clocks, because they periodically obtain the time from the chassis 10.

The CCM sends command codes to the appliances, similar to the command codes that a traditional appliance receives from a remote control unit. In fact, the CCM itself is controlled by a remote control unit 20, henceforth referred to as “the chassis remote” or simply “the remote.” The chassis remote sends messages to the chassis 10, and these messages are processed by the CCM, which in turn controls the appliances. This is the same function that is traditionally performed by a remote control hub. The preferred embodiment of the invention dramatically improves on the traditional remote control hub, by integrating its function into the content switcher chassis, thus creating a remote control hub that is actually cabled to its controlled appliances.

In the preferred embodiment of the invention, the appliances do not need individual remote control units or sensors, because they are controlled entirely by the CCM. Therefore, the concept of a “universal remote” is inherent; the entire system, including the CCM-ready appliances, the television 38, and the CCM itself, can be controlled natively by a single remote 20.

Unlike traditional appliances, all CCM-ready appliances share a standard command code set, which is used by the CCM to control the appliances. Henceforth, said command code set is referred to as the CCM code set. All CCM-ready appliances, and the CCM itself, are manufactured with the CCM code set preinstalled. If the chassis 10 has an Internet connection, it will periodically download the latest edition of the code set and push it out to all connected CCM-ready appliances. The CCM also pushes the code set out to the chassis remote 20 as needed. This feature is called auto learning.

For the user's convenience, the invention allows the attachment of legacy appliances. This allows the user to attach a mix of old and new appliances to the same chassis. Naturally, legacy appliances do not enjoy the full functionality of the present invention. They can be controlled by the CCM, via IR transmitters built-in to (or attached to) the chassis 10. But this communication is unidirectional, and requires manual learning. That is, the user will have to perform the same procedure used by traditional universal remotes, to learn the command codes of the legacy appliances. Auto learning and manual learning are both indicated in FIG. 7.

There are several methods of manual learning, and all of them are supported by the CCM. However, each legacy appliance will vary as to which methods can be used. For example, many appliances can be learned by simply typing the model number, and the CCM can look it up in a database of known model command sets. In the worst case, the original remote of the legacy appliance will have to be beamed at a sensor in the chassis 10, to teach the command codes to the CCM. This method can be unpleasant, because it only learns one command at a time. Whichever method is used, the manual learning procedure is exactly the same with the present invention as it is with traditional universal remotes.

With today's systems, manufacturers seem unwilling to agree on a standard command code set. However, in an environment where CCM-based chassis are popular, appliances will have to use the CCM code set, in order to be considered CCM-ready. All CCM-ready appliances must have the CCM code set preinstalled, and must fully comply with the code set. However, because not all appliances support all functions, it is assumed that each appliance will only support a subset of the code set. For example, if the CCM code set uses the number 17 for the Record command, then all appliances must be aware that code number 17 means Record, even appliances that do not have recording functionality.

When an appliance registers itself, it submits to the CCM a list of which command codes it supports. It need only specify the numbers, because the CCM already knows the command names assigned to the codes. In the cited example, where the CCM code for Record is the number 17, appliances that have recording functionality will include the number 17 in their list of supported codes, and non-recording appliances will not. If an appliance does not submit the number 17 in its list, the CCM knows that said appliance does not support the Record command, and so the CCM will never issue the code number 17 to said appliance.

In the CCM code set, any command that is a “toggle” command is accompanied by corresponding discrete commands. For example, if there is a “Pause/Play Toggle” command, there are also two discrete commands, “Pause” and “Play.” If an appliance supports a toggle command, it must support the corresponding discrete commands. When an appliance submits its list of supported code numbers, it does not submit the code numbers for said discrete commands, because their support is implied. For example, if the CCM code set uses the number 20 for the “Pause/Play Toggle” command, and 21-22 for the discrete commands “Pause” and “Play,” then any appliance which supports code 20 must also support codes 21-22. Such an appliance submits only the number 20 during registration, and the other two numbers, 21-22, are implied.

It is permitted for an appliance to have unique or proprietary functions that are not included in the CCM code set. In this case, during registration, the appliance submits these commands to the CCM as text strings. For example, a video game system might have a proprietary command called “Pumpkin” which causes a video game character to throw a pumpkin. In this event, the appliance announces during registration that it has a command called “Pumpkin,” and then the CCM will assign a code number to be used for this command. Said assignment need not be permanent, and is limited to that specific appliance, unless the official CCM code set is eventually modified to include this new command.

The chassis 10 also uses a cable to supply power to the appliance. Depending on the size and function of the appliance, and the manufacturing capabilities, the appliance power may be supplied via the content cable 34, or by a dedicated power cable attached to the chassis 10. Unlike most traditional appliances, which remain in a low-power standby mode when they are powered off, all CCM-ready appliances are in a completely powered-down state when not in use, and the CCM delivers power to each appliance only when it is needed. The only component that is always on is the CCM itself.

Many traditional appliances are required to stay powered on 24/7, even when not in use, because they need to perform some background functions. For example, a cable-box may need to download TV program guides from the service provider every half hour; or a DVR may need to record programs at certain times that have been scheduled by the user. In the preferred embodiment of the invention, even appliances that require constant background functions can remain powered off, because the CCM assists with said background functions.

The CCM can periodically download TV program guides from a service provider when the cable-box appliance is powered off. When the cable-box appliance is powered on, it can access the program guide information that has been downloaded by the CCM. If the user schedules recordings on the DVR, the CCM is notified of the recording schedule, and will automatically power on the DVR appliance when the scheduled time is near, and power it off after the scheduled recording has finished. Similarly, if any appliance has background tasks that need to be performed, it simply notifies the CCM. The appliance provides the CCM with detailed instructions on how to perform the background task, and the CCM performs the task when the appliance is powered off.

CCM-ready appliances do not even need to connect to the Internet or the home network at all. The CCM can act as a proxy for all network activity. This means that the manufacturers do not need to add networking drivers or protocols, such as IP or Ethernet, to their appliances. The CCM supports three levels of network access for appliances, and each appliance can specify during registration which level it prefers to have:
1. Full access, wherein the appliance will have its own IP address to connect to the Internet or the home network.
2. Proxy access, wherein the appliance will not have its own addresses, but the CCM can act as a proxy, and perform any needed network activities for the appliance, such as downloading files or streaming content. This is similar to the background task feature mentioned earlier, except that with this proxy access setting, the CCM will always perform the appliance's network tasks, even when the appliance is powered on.
3. No access, wherein the appliance does not require any network access at all, directly or via proxy.

Any time the CCM needs an appliance powered off, it attempts a graceful shutdown of the appliance. This graceful power-off is similar to the “shutdown” feature of a PC. The CCM first issues a PowerOff command to the appliance. If the appliance is a CCM-ready appliance, then said appliance will implement its own graceful shutdown procedure; for example, performing a Pause or Save function. For legacy appliances, this is typically also the case, but may not be true for all appliances. If the appliance that is being shut down, whether CCM-ready or legacy, is receiving its power from the chassis 10, then the CCM will cut off the power to said appliance shortly after sending the PowerOff command.

The present invention has an initial setup procedure, similar to the setup procedure of traditional appliances. All of the information and settings entered by the user are stored in a profile called a chassis profile. Multiple chassis profiles may be used for multiple users, or a household may simply have a single shared chassis profile. Each chassis profile may optionally be assigned a password.

In the preferred embodiment of the invention, it is not necessary to repeatedly perform the setup procedure on every appliance. When a CCM-ready appliance performs its initial registration, it will request any information or settings that it needs from the chassis profiles. In the case of an Internet streaming appliance, this will include the user's login account information for one or more streaming channel services. If any of the chassis profiles are password protected, those users will be prompted at this point to enter their profile passwords. Alternatively, a password-protected chassis profile may be configured to auto-accept profile requests from appliances, allowing appliances to receive the profile settings without the password requirement.

In the preferred embodiment of the invention, the user has the option of configuring advanced settings, but typically will not need to. For example, some universal remote systems require the user to create scripts for the activities they wish to perform. With these systems, if the user would like to watch DVDs, they would have to create a script for the “Watch DVD” activity. The user would enter information about which devices need to be turned on, which device controls the volume, and which input port should be selected on the television or content switcher. This would create a script for the “Watch DVD” activity, and the script would power the correct devices on and off, and perform the input selection process, whenever the user chooses the “Watch DVD” activity on the remote.

In the preferred embodiment of the invention, it is not necessary for the user to configure these activity scripts. This is because the remote control hub and the content switcher are integrated functions, consolidated in a single processor. With traditional remote control systems, the remote, or the remote control hub in a hub-based system, has almost no knowledge of the appliances it is controlling, other than knowing their command codes. With the present invention, the remote control hub is the CCM itself, and so it has all of the essential information about the appliances, obtained during the registration procedure. And because the remote control hub (the CCM) is also the content switcher, it knows exactly when and how to select inputs, without having to be configured by the user, and without having to learn or transmit content switcher commands.

Consider an example, in which a chassis 10 of the present invention has two CCM output ports (Output Ports 1-2), eight cartridge slots 18 (Input Ports 1-8), four CCM input ports (Input Ports 9-12), four HDMI input ports (Input Ports 13-16), two AUX input ports (Input Ports 17-18), and a set of speakers controlled by an A/V receiver cartridge 12. In the example, the following appliances are attached:

### Output Ports

1 (CCM output port 1): the primary television 38.
2 (CCM output port 2): a spare television 38.

### Input Ports

1 (Cartridge slot 1): a CCM-ready Internet streaming device.
9 (CCM input port 1): a CCM-ready DVD player.
10 (CCM input port 2): a remote-controlled thermostat system (not a content source).
13 (HDMI input port 1): a legacy DVD player.
17 (AUX input port 1): an old cassette tape player (not remote controlled).

Depending on the current time period's technological state, and the ability of the manufacturers, the “CCM” ports and cables 34 may be a current or future variation of HDMI, or perhaps a future cable specification—perhaps one created specifically for the present invention.

Like many existing universal remotes, the chassis remote 20 has a touchscreen display screen. The main menu on the chassis remote 20 is a list of appliances, from which the user can select an appliance by tapping its label. Many traditional universal remotes also have a menu that lists the controlled devices, but in the chassis remote's 20 main menu, the appliance list is actually a numbered list of the input ports on the chassis 10, including the cartridge slots 18. Each port is listed as a port number, followed by a label. In the example chassis (see port list above), the first CCM port is Port 9, because the cartridge slots 18 are Ports 1-8. This port would be listed as “9 CCM-1” in the remote's 20 main menu.

The chassis remote's 20 main menu has two modes: Normal mode and Setup mode. Setup mode is used to configure the items in the main menu. In Normal mode, the main menu only shows the chassis 10 input ports that are known to be in use. In Setup mode, all of the input ports are displayed, even unused ports. This allows the user to tap an unused port, and configure it for use.

CCM-ready appliances require no user setup at all. Recall that when a CCM-ready appliance is attached to the chassis 10, via cable or as a cartridge 12, it automatically performs the registration procedure with the CCM, which includes the command code auto learning. The CCM then edits the appliance's port label in the remote's 20 main menu, and enables it to appear in Normal mode. The user may also edit the label if they choose. In the example chassis 10, there is a CCM-ready DVD player attached to Input Port 9. Suppose it is a Model “XYZ123” DVD player. During registration, the CCM learns that it is a DVD player, and learns the model number, and automatically changes the label from “CCM-1” to “DVD XYZ123.” The port number is unchanged, so the appliance is listed in the main menu as “9 DVD XYZ123.”

The items in the menu are sorted numerically by input port number. If the user switches the remote 20 to Setup mode, they can edit the labels of the items, but cannot change the port numbers that prefix the labels. In this example, the user could change the Port 9 label to “My DVD player,” and the item would be listed as “9 My DVD player.” If, for some reason, this same DVD player is moved to port 10, the CCM will simply adjust the menu automatically, and move said appliance to the Port 10 position. (It will know that it's the same appliance, because of the registration.)

Legacy devices, like the DVD player in Port 13, do not appear on the menu automatically. They require some user configuration, but only the command code learning described earlier. There is no need to configure activities or scripts. The user simply puts the remote 20 in Setup mode, taps the port number of the legacy appliance, and then uses whichever manual learning method works for that appliance.

The cassette tape player attached to Input Port 17 is also a legacy appliance, but it is not remote controlled, so it requires no command set learning. However, the user needs to edit the on-screen label for port 17. Recall that in Normal mode, the remote's 20 menu only shows ports that are known to be in use. Since a non-controlled appliance has no learning procedure, the CCM does not know it is there, and will not list its port in Normal mode, unless the port's label is modified. Any port with a modified label is assumed to be in use, and is always shown in the main menu. Naturally, the CCM cannot control this cassette player, but it can use it as a content source, and play its music on the television 38 or stereo speakers. The user will need to manually press the Play button on the cassette player to play the music.

Special appliances like cable-boxes and DVRs may have both inbound and outbound content. When such appliances are built as cartridges 12, they are called pass-through cartridges, and they announce this property during registration. If an input port is attached to a service provider cable 30, such as a CATV cable providing content from a wall jack, the user can configure it as a provider port. If a port is configured as a provider port, its content is automatically sent to all pass-through cartridges, at all times, regardless of what is selected as the active content source. This is the default behavior, but the system's Advanced menu allows user to customize which appliances receive content from which ports.

If a provider port is selected as the active content source, its content is sent directly to the television 38, but said content is also still sent to pass-through cartridges 12, in case they need to record it. If a pass-through cartridge 12, like a cable-box for example, is selected as the active source, the user can then use the cable-box's menu to select what to watch via the cable-box. This could include watching the content that is currently entering the cable-box from a provider port. It is also possible to configure an external appliance 32 as a pass-through appliance, but this is more complex, and may require attaching two content cables to the appliance, depending on whether manufacturers are able to support bidirectional content traffic on a single cable 34.

After the remote's 20 main menu setup is completed, the chassis 10 system is ready to use. Each time a user wants to use the system, the following steps occur, with the remote 20 in Normal mode:
1. (Optional) The user selects a destination using the remote 20. If a system has multiple output devices, as is the case in this example (two televisions, and a speaker system), the CCM automatically selects the television 38 with the lowest port number as the default destination for video content. If the chassis 10 has an A/V receiver with speakers, said A/V receiver is automatically used as the default destination for all audio content; otherwise, audio content is sent to the same television 38 as the video content. Therefore, the user does not need to select a destination. However, if they choose, the user may use the remote's 20 Advanced Settings menu to select a destination, to change the defaults, or to have the Select Destination option always appear on the main menu.
2. The user selects an item from the main menu. Naturally, when the user selects an item, they are actually selecting an input port. The remote 20 transmits the selected port number to the CCM, which then sets the status of the selected item (the appliance or service cable attached to that input port) according to the following rules:
   a. If the selected item is both a remote controlled appliance and a content source, which is the most typical scenario, then said selected appliance is assigned as both the currently controlled appliance (the recipient of subsequent appliance control commands issued by the remote 20), and the currently active content source (the one source whose content is forwarded to the television 38, or other selected destination).
   b. If the selected appliance is a remote-controlled appliance, but not a content source (like the thermostat system in the example), then said selected appliance is assigned as the currently controlled appliance; but no active content source is assigned.
   c. If the selected appliance is a content source, but not remotely controlled (like the cassette player in the example, or a provider port), then said selected item is assigned as the currently active content source for the selected destination; but no controlled appliance is assigned.
3. The newly selected appliance is powered on if applicable.
4. The previously selected appliance is powered off, if applicable.
5. If the chassis 10 has an A/V receiver, it is powered on or off, depending on whether it is needed for the current activity.
6. The television 38 will be powered on if any of the following are true, or it will be powered off if none of the following are true:
   a. The selected item provides audio content, and external speakers will not be used. In this case, the television 38 is powered on to provide audio.
   b. The selected item requires the use of an on-screen menu, such as a setup menu or a CD track list, and said menu cannot be displayed on the remote 20. The present invention allows appliance menus to be displayed on the remote's 20 display screen instead of on a television. This allows the user to access an appliance's setup menus, or play audio files or CDs, without using a television. The appliance simply sends the menu text to the remote 20 via the bidirectional control channel. However, if an appliance (for example, a legacy appliance) does not support this feature, then the television 38 must be powered on to display said menus.
   c. The user has selected an item (or option) that provides video content; for example, the user might use a DVD player to watch a movie. When the user selects the DVD player appliance from the remote's 20 main menu, the CCM is not certain that video content will be involved; sometimes DVD players are used to play audio CDs. The user will see the DVD player's menu displayed on the remote 20. When the user selects the menu option to play a DVD movie (or any option that displays video content), the CCM then powers on the television 38.
7. The user may now control the selected item using the remote 20. All appliance control codes issued by the remote 20, such as Play or Pause, are forwarded by the CCM to the controlled appliance, if there is one. Audio commands such as Volume or Mute are forwarded to the appropriate audio device (television 38 or A/V receiver, for example).

In the preferred embodiment of the invention, having two or more CCM-ready appliances of the same model does not cause any remote control malfunctions. With traditional appliances, sometimes a user issues a command to an appliance via remote, but the command is unintentionally sent to another appliance of the same model, because it is in the vicinity, and shares the same command codes. CCM-ready appliances, regardless of make and model, all use the same code set; however, since individual appliances do not have remote sensors, there is no risk of an appliance receiving a signal that was not intended for it.

Some appliances may require storage space to store files or other data. For example, a DVR needs space to store its recorded TV programs. In addition, the CCM itself might need storage space to save chassis profiles and other miscellaneous data. Storage space may be hard disks, flash drives, or some other media. In the preferred embodiment of the invention, the chassis 10 contains a user-selectable amount of storage space, which is available for the CCM and CCM-ready appliances to use.

Some of the chassis storage space may be shared, and some may be allocated to a specific appliance. For example, there may be a storage area in the chassis 10 specifically dedicated to a DVR appliance for saving recorded TV shows. Note that this storage space, even when dedicated to a specific appliance, is not physically located on the appliance itself. Manufacturers do not need to include storage space in their appliances, because they know that storage space will be provided by the chassis 10.

In the preferred embodiment of the invention, various models of the chassis 10 may have various sizes, with various functionality. Some models may be very large models, and contain large amounts of storage space. The storage space may be built-in; or it may be inserted as cartridges 12, or may even be externally attached. Some chassis 10 models may contain special storage slots 18, which are made specifically for removable drives. The number and arrangement of chassis slots 18 may also vary widely by model. Some models may allow the user to stack (or daisy-chain) multiple chassis 10 together, to be controlled by a single CCM. This allows the user to have a large number of appliances, or a large amount of storage, or both.

Many households today have a device called a Network Attached Storage (NAS) server. This device is connected to the home network and contains an ample amount of storage space. Users can store files on the NAS server, and access those files from any networked device in the house. The most common use for a NAS server is to store media files, such as photos, music, and videos. The preferred embodiment of the invention has the ability to function as a NAS server, if it contains a NAS appliance cartridge 12 and the necessary storage space.

Most A/V receivers can retrieve media files from a NAS server via the home network, and play them on the television 38 and/or the speaker system. As stated earlier, the preferred embodiment of the invention has the ability to function as an A/V receiver. In this case, the invention can play media files from a NAS server on the television 38 and/or speakers; and, if the same chassis 10 is also the NAS server, there is no need to traverse a network to retrieve the media files.

Some of the appliances made today contain an optical drive, such as a DVD or Blu-ray drive. It's important to note the distinction between an optical disc player, such as a DVD player, and an optical disc drive. A DVD player is an appliance that is sold to consumers, often in department stores. In contrast, a DVD drive (also called a DVD reader or writer) is one of the components inside of a DVD player, which physical holds and reads an optical disc, and is not much larger than the disc itself. It is essentially the same as the DVD drive included in many PCs.

Examples of appliances that use optical discs include DVD players and video game systems. With traditional appliances, the optical drive is embedded in the appliance. For example, if a user purchases a DVD player and two video game systems, each of these appliances will have an embedded optical drive. Therefore, the user has purchased three optical drives, even though only one of them can ever be used at a time, if they are all connected to the same TV. This is extremely wasteful. In the preferred embodiment of the invention, such appliances do not need to have an optical drive embedded directly in the appliance. The chassis itself can have a single optical drive, either built-in or inserted as a cartridge 12, and all such appliances can share it.

A traditional DVD player (or video game system) has three main elements. The first element is a circuit board containing various electronics and the firmware that operates the device. This provides the user interface, including the menus that allow a user to watch the content or play games. The second element is a DVD drive which physically reads the discs. And the third element is the accessory items; that is, the fan, power supply, cables, external connectors, etc., and the case that houses the whole thing.

In the preferred embodiment of the present invention, a DVD player containing the three elements above can be formed using three separate components of the chassis 10. The first element—the circuit board containing the firmware—is the primary element, and can be inserted as an appliance cartridge 12. The second element—the DVD drive—can be a shared optical drive located in the chassis 10, as described above. This, too, may be a cartridge 12. As stated, this drive may be shared by other appliances. The third element—the accessory items—are provided by the chassis 10 and shared by all cartridges 12, as described earlier in the document. The point of this dissection is that a “DVD player” can actually be comprised of several separate components, which are all user replaceable. If any one of those components fails, the other components do not need to be replaced or discarded. Or, if a new model of optical disc drive is released by manufacturers, and is more efficient or desirable than the model currently in the chassis 10, it is possible to replace the optical drive without replacing the other elements of the disc-based appliances. This single disc replacement provides a hardware upgrade for multiple disc-based appliances.

Naturally, like any content switcher, the chassis 10 of the present invention contains various input and output (I/O) ports; for example, today's systems usually have HDMI ports, and may also have CATV ports, RCA ports, etc. Like the content appliances, these ports can be embedded on removable cartridges 12, rather than on the chassis itself. That way, as future cable and port types emerge, the chassis 10 can be updated by simply replacing the I/O cartridges 12.

In the preferred embodiment of the invention, cartridge slots 18 on the chassis 10 have a few different sizes; but the slot sizes and the cartridge connections are standardized, so that all components, including the chassis 10, will work together, even if produced by different manufacturers. Naturally, input and output ports are produced on small cartridges 12 (or cards), while appliances generally require larger sizes. A chassis 10 manufacturer may choose to build a chassis 10 with a removable divider between slots 18, thus allowing a user to form a double-width slot or a double-height slot by removing said dividers. Naturally, this means that a manufacturer who needs to build a large appliance may build said appliance as a double-width cartridge 14 or a double-height cartridge 16.

Throughout this document, some components are described as being located in the chassis 10. Examples include the CCM and possibly the chassis storage. Other components are described as being inserted as cartridges 12. Examples include the NAS server and A/V receiver. However, in the preferred embodiment of the invention, any supported component may exist as a cartridge 12, or as an external appliance 32, or can be built in to the chassis 10. In fact, it is possible for the chassis 10 to be essentially just a shell, with no functional components whatsoever. All functional components, even the CCM, can be added as cartridges 12 or external devices. Implementing the CCM as a cartridge 12 allows the user to upgrade said CCM to a newer model, or replace it if it fails, without having to replace the entire chassis 10.

It is up to the chassis 10 manufactures to decide which components are built-in and which components are added as cartridges 12 or external devices. Cartridge 12 manufactures may also build cartridges 12 containing household devices that do not provide A/V content, but are convenient to have located in the chassis 10. Examples include a network switch, a wi-fi access point or router, a home thermostat system; or any other devices that manufacturers can think of, which may be convenient to locate in the chassis 10.

### ALTERNATIVE EMBODIMENTS OF THE INVENTION

The previous section described the preferred embodiment of the present invention, and included many features that are desirable, but not necessary to the invention. Alternative embodiments of the invention include any devices or systems that provide any combination of one or more of the original features described in the preferred embodiment of the invention.

For example, the preferred embodiment has a chassis 10 that accepts three types of appliances:

1. CCM-ready appliance cartridges 12, and
2. CCM-ready external appliances 32, and
3. Legacy (non-CCM-ready) external appliances.

Alternative embodiments might not accept all three of the above appliance types, but might accept any combination of one or more of said appliance types. The preferred embodiment of the invention is intended primarily for connection to audio-video content sources (and destinations). However, it also allows connections to other appliances. This is for convenience, so that many household appliances, those that relate to audio-video content and those that do not, can all be operated by the same universal remote. Alternative embodiments of the invention might not accept both content and non-content appliances.

The preferred embodiment of the invention includes several optional features, such as: shared storage space, the bidirectional control channel, the appliance registration procedure, CCM background task handling, slots 18 for cartridges and I/O ports, the ability to provide power to connected appliances, and the ability to stack multiple chassis 10. Alternative embodiments of the invention might exist without these optional features, or with any combination of one or more of these features. The preferred embodiment of the invention combines content, control traffic, and power on the same cable 34. Alternative embodiments may provide any combination of these elements, and may carry any combination of the supported features on the same cable 34. In a future time period, it is possible that wired transmission may become outdated. However, the transmission path used for content, even if it is wireless, is still certain to be superior to the infrared signals used by most traditional remotes. Therefore, even though the CCM's control channel will not be carried “on the same cables as the content,” it will still use the same transmission medium as the content, because the CCM is the content switcher.

Alternative embodiments of the invention may exist without a standardized command set, or with a standardized command set that does not have all of the rules specified in the preferred embodiment. It is preferred that one common standard is used by all manufacturers, not only for the command set, but for other characteristics, such as the size, shape, and connector specifications of the cartridges 12 and slots 18, and any other characteristic that may have the potential to be standardized. However, it is possible that multiple standards will exist, and appliance manufactures will have the option of building appliances for any of said standards or for multiple standards.

In the preferred embodiment of the invention, appliances that use on-screen menus, such as configuration menus or audio CD track listings, can transmit said on-screen menus for viewing on the display screen of the remote 20. In alternative embodiments of the invention, these menus may be handled the traditional way; that is, transmitted only to the content destination, which is typically a television 38. However, the content destination does not have to be a television, and may even be the remote 20.

In an alternative embodiment of the invention, the remote 20 may have a video screen, similar to the screens on many mobile phones. The remote 20 can be configured as an audio-video content destination, and the chassis 10 (or, perhaps, the appliance itself) can stream audio-video content to the remote 20, similar to the way some existing devices stream content to mobile phones and tablets. In yet another alternative embodiment, there might be no ability at all for the remote to display any appliance's menus or on-screen text. Additionally, in the preferred embodiment of the invention, the display screen on the remote 20 is a touchscreen. Although it would be less pleasant, the same functionality could be provided without using a touchscreen.

In the preferred embodiment of the invention, the word “content” is presumed to indicate audio-video content, consisting of audio or video or both. However, it is possible that other types of content may exist, now or in the future, and these other types of content may be controlled by alternative embodiments of the present invention, using the same methods described in this document to control audio-video content.

In the preferred embodiment of the invention, it is presumed that each content source and each content destination is a physical device, such as a DVD players (source) or a television 38 (destination). However, in alternative embodiments of the invention, any content source or content destination may be a software application, or a virtual machine, rather than a physical device. Said application or virtual machine may be either internal or external to the chassis 10.

I claim:

1. A chassis system, comprising:
a) a chassis, with a plurality of communication ports, said ports receiving content from content source appliances; and
b) a remote control unit, which transmits control codes intended to control appliances; and
c) a processor, located in the chassis, said processor performing three functions:
i) the function of a traditional content switcher, said function being the selection, at any given time, of which content source is currently the active content source for a given content destination, said active content source being the one and only content source whose content is currently forwarded to said content destination; and
ii) the function of a traditional remote control hub, said function being to receive control codes from one or more remote control units, and forward each said control code to whichever appliance or other entity is the intended recipient of said control code; and
iii) the integration of said content switcher function with said remote control hub function, such that selecting a remote-controlled content source appliance as the controlled appliance and selecting that same appliance as the active content source are consolidated into a single action; said integration occurring with no need for user-configured activity scripts.

2. A chassis system as cited in claim 1, wherein said content is audio-video content.

3. A chassis system as cited in claim 2, wherein said audio-video content is separated into audio content and video content, and said audio content is directed to audio equipment, while said video content is directed to video equipment.

4. A chassis system as cited in claim 1, wherein ports on said chassis may connect to any combination of the following types of entity:
a) an entity which provides content, and is a remote-controlled appliance; or
b) an entity which provides content, and is not a remote-controlled appliance; or
c) an entity which does not provide content, and is a remote-controlled appliance;
wherein, for each communication port on said chassis, said processor will perform either said content switcher function, or said remote control hub function, or both functions, depending on the type of entity connected to said port.

5. A chassis system as cited in claim 1, wherein appliances can be configured as pass-through appliances, said appliances receiving content from a source like a service provider wall jack, and also transmitting content to a destination such as a television.

6. A chassis system as cited in claim 1, wherein said control message communication between said processor and said appliances is carried on the same cables that carry content between said appliances and said chassis.

7. A chassis system as cited in claim 1, wherein control message communication between said processor and said appliances is bidirectional.

8. A chassis system as cited in claim 7, wherein said appliances perform a registration procedure with said processor, during which said appliances announce their identities and other properties.

9. A chassis system as cited in claim 8, wherein said registration procedure includes control code negotiation, such that no additional task is required for said processor or said remote control unit to learn control codes for said appliances.

10. A chassis system as cited in claim 9, wherein said control codes include standardized codes for well-known functions, such that various appliances, even those of different manufacturers, use the same standard control codes for said functions.

11. A chassis system as cited in claim 1, wherein said chassis supplies the power to said appliances.

12. A chassis system as cited in claim 11, wherein said processor keeps all appliances in a completely powered down state, except when said appliances are actively in use, or when said appliances need to stay powered on to perform unattended background tasks.

13. A chassis system as cited in claim 12, wherein said processor performs said background tasks on behalf of said appliances; thus eliminating the need for said appliances to remain powered on for said background tasks.

14. A chassis system as cited in claim 11, wherein said supply of power to said appliances occurs on the same cables that carry said content between said appliances and said chassis.

15. A chassis system as cited in claim 1, wherein said appliances are manufactured as cartridges, said chassis having slots made specifically for insertion of said cartridges.

16. A chassis system as cited in claim 1, wherein additional functionality may be provided, by inserting cartridges or cards with external physical input/output ports.

17. A chassis system as cited in claim 1, wherein an expandable shared storage area can be attached to the chassis, internally or externally, and used by all devices attached to the chassis, thus making it easier to provide storage to the devices, and eliminating the duplication of data on multiple devices, and the duplication of work entering said data into multiple devices.

18. A chassis system as cited in claim 1, wherein said system contains both an A/V receiver and a NAS server, thus allowing the A/V receiver to access media files from the NAS server without needing to traverse a network.

19. A chassis system as cited in claim 15, wherein a DVD player appliance, video game system, or similar optical disc-based appliance, can be formed by using a standard PC-type optical disc drive, and a firmware chip to provide the appliance's user interface and other functionality, both attached to the same chassis which supplies additional components such as power supplies and fans; said system allowing a single optical disc reader to be shared by a plurality of said optical disc-based appliances; said system allowing such an appliance to be replaced, when needed, one component at a time, rather than having to replace an entire appliance if a single component malfunctions, or if a new model of optical disc drive becomes available on the market.

20. A chassis system as cited in claim 1, wherein appliances may be manufactured without networking software, drivers, or protocols; said appliances having the ability to use the chassis processor as a network proxy, said processor performing any needed network activities on behalf of said appliances.

21. A remote control system, wherein remote-controlled appliances that use on-screen menus, such as setup menus and audio track listings, can transmit said on-screen menus to said remote control unit for display, making it possible to use said appliances with said menus, without needing to power on a television.

22. A remote control system, wherein said remote control unit can receive audio-video content from content source appliances, and display the content for viewing on a video screen built in to said remote control unit.

23. A remote control system, wherein any toggle command that exists is accompanied by a corresponding set of discrete commands, such that no action is selectable exclusively via toggle command; wherein remote control units may be manufactured with said toggle commands, and without said discrete commands, provided that said discrete commands do exist, and are available for use in scripts, thus eliminating the most common cause of remote control script malfunctions.
